(19) United States
(12) Patent Application Publication
(10) Pub. No.: US 2022/0373447 A1
(43) Pub. Date: Nov. 24, 2022

(54) SYSTEM FOR MONITORING PARTICLE CONTAMINATION IN POWER PRESSURE SYSTEMS

(71) Applicant: Jason Eric Green, Davie, FL (US)

(72) Inventor: Jason Eric Green, Davie, FL (US)

(21) Appl. No.: 17/746,566

(22) Filed: May 17, 2022

Related U.S. Application Data
(60) Provisional application No. 63/190,048, filed on May 18, 2021.

(51) Int. Cl. G01N 15/02

(52) U.S. Cl. CPC G01N 15/0205; G01N 2015/0046

(57) ABSTRACT

A system structured to monitor particle contamination of different equipment or machinery categories including power pressure systems having a monitoring module. The monitoring module includes an intake structure and an exhaust structure, wherein the intake structure is connected in fluid communication with an air intake or air supply the power pressure systems being monitored. The monitoring module further includes alarm capabilities structured to communicate alarm signals to local and remote operating personnel. In addition, a particle sensor module is structured to determine predetermined particle characteristics of an air sample received from the power pressure systems. An electronic control module (ECM) is connected in on-off activating relation to the intake and exhaust structures and the particle sensor. As such, the ECM is operative to capture and analyze an air sample from the power pressure systems within said particle sensor and categorize the particle characteristics within the captured air sample as normal or abnormal dependent on levels of contamination.

The present non-provisional patent application claims priority pursuant to 35 U.S.C. § 119(e) to a currently pending and prior filed provisional patent application having Ser. No. 63/190,048, and a filing date of May 18, 2021, the contents of which are incorporated by reference herein, in its entirety.

### BACKGROUND OF THE INVENTION

### Field of the Invention

The present invention is directed to a system structured to monitor particle contamination of various types of machinery and/or positive pressure systems and includes a monitoring module operatively connected directly to the machinery to be monitored. The monitoring module includes an electronic control module (ECM) structured and/or pre-programmed to control the operative components of the monitoring module and thereby effectively determine the existence or nonexistence of particle contamination.

### Description of the Related Art

Industrial machinery including internal combustion engines, combustion turbines, crushers, conveyor systems, etc. require clean air for reliable operation. This air may be required for various purposes including combustion, cooling, compression or other uses. For most industrial machinery, the air supply requires careful pre-treatment to ensure that air taken from the surrounding environment is free from particulate contamination. The failure of machine air filtration systems is a common problem and such failures allow unfiltered air to enter combustion chambers, gearboxes, machinery spaces, etc. causing loss of performance and efficiency, premature wear or in some cases—catastrophic failure. Air induction system failures can be caused by physical damage to air ducting, broken connector hoses, broken hose clamps or fasteners, machine housing gasket failures or failures of air filtration media. In addition, human error during machine maintenance is a common cause of induction system failure. The problem of unfiltered air entering a machine is known as ‘dust ingress’ or colloquially as ‘dusting’ and is a widespread problem across many industrial sectors where engines and machinery routinely operate in severe environments. Such events can quickly lead to significant repair or replacement costs, machine downtime and loss of production. Dust ingress can be a significant operational challenge in many industrial sectors that routinely operate in severe environments including: Mining, Quarries, Cement Plants, Construction, Oil and gas, Power generation, Agriculture, Forestry, Marine, Rail, On-highway trucks.

### Internal Combustion Engines

Engines require a clean source of air for combustion and reliable operation. Typical engine designs utilize air induction systems that take air from the surrounding environment, filter it for particulate contamination, and then route the clean air to the engine's combustion chambers. The failure of engine air induction systems is a common problem and such failures allow unfiltered air to enter the combustion chamber causing loss of performance, engine wear or severe engine damage due to the abrasive nature of particles commonly found in dust. Specifically, engines are particularly susceptible to silica particles (silicon dioxide) that are harder than the typical metals and alloys used in the construction of liners, rings and pistons. In severe operating environments, silica can make up a significant portion of ambient dust.

### Combustion Turbines

Combustion turbines require large volumes of clean air for reliable and efficient operation. The problem of dust ingress effects combustion turbines as abrasive particles can damage compressor section blades and other components thereby lowering efficiency and power output. In extreme cases, dust ingress can cause total failure of combustion turbines. In addition to dust ingress, combustion turbines located near coastal areas are vulnerable to airborne salt particles that can react with fuel in the combustion process and cause degradation of turbine blades and other internal components. Dust ingress/salt particle contamination is a common problem for combustion turbines used in: Power generation, Compression, Pumping.

### Machinery/Gearboxes

Dust ingress impacts a variety of other machinery routinely operating in severe/dusty environments including: Rock crushing machinery, Concrete plants, Conveyor systems.

### Current ‘Best Practices’ for Determining Particle Contamination

Current industry best practices for detecting and fixing air induction system leaks do not provide adequate or timely feedback to operators of critical machinery. Induction system leaks are typically found by either visual inspection during a scheduled maintenance inspection or through oil analysis. Both of these methods occur during routine maintenance procedures that occur too infrequently to protect engines from dusting damage. Induction system leaks that develop after a routine maintenance inspection can result in hundreds of hours of machine operation with highly damaging particle contamination. Extended machine operation with contaminated air can result in premature wear and damage to internal components. In severe operating environments with high abrasive particle concentrations, severe or catastrophic damage can occur in a matter of minutes.

### SUMMARY OF THE INVENTION

The present invention is directed to a system for monitoring the existence of particle contamination in various types of positive pressure systems including, but not limited to, machinery during the operation thereof. In addition, the monitoring system determines whether such particle contamination, if in fact present, is that a level which is normal and/or acceptable or, to the contrary is sufficiently abnormal to present machinery damaging levels of contamination. It is to be noted that use of the term “machinery” and/or “machinery being monitored” and/or its equivalent refers to different positive pressure systems, which may include high-pressure electrical vault, off-road machinery with pressurized operator cabs, etc.

As such, the monitoring system of the present invention has been designed to protect engines, combustion turbines, gearboxes and related machinery from dusting-related damage by actively and continually monitoring induction system air for the presence of particles. The system includes an integrated monitoring module having particle sensing capabilities, preferably using optical sensing technology to detect particles. More specifically, when the optical sensing technology is utilized, at least one embodiment may comprise laser light scattering capabilities, which may include an integrated optical particle sensor operates using laser light at 660 nm (red).

As explained herein, the term “particles” and/or “particle contamination” generally, but not exclusively refers to particles of dust. However, depending on the environment and/or ambient condition in which the monitored machinery operates, particles other than or in combination with dust particles with may also be detected and analyzed for contamination.

By way of nonlimiting example, such particles may include dust, salt particles, etc. of a predetermined size, such as between generally about 0.5 and 10 microns in diameter. Particles in this size range pose high risk to different types of machinery and/or positive pressure systems as they are able to lodge within machine oil films causing mechanical abrasion of metals, loss of hydrostatic lubrication and rapid wear and damage to internal components. Critically, the system of the present invention alerts operators and local/remote supervisory personnel when an induction system leak has been detected so that the machine can be shut-down and repaired before damage occurs. Further, the system of the present invention provides alerts to local machine operators by incorporating alarm capabilities, which may include, but not be limited to, warning lights and audible alarms. Concurrently, operative components of the system of the present invention communicate induction air status remotely via ‘telematics’ to alert supervisory maintenance personnel of the unsafe condition. The present system may also provide a ‘customer contact relay’ to allow for activation of additional controls or alarms as well as automatic shutdown of unmanned machines.

### Operational and Structural Features

Accordingly, one or more preferred embodiments of the system of the present invention may include the following components: Weatherproof housing/module, Air sampling intake orifices, Air sampling manifold, Pressure sensor, Air sample solenoid control valves, Particle sensor and sensor housing, Air sample exhaust solenoid control valve, air sample exhaust outlet orifice, Air pressure sensor, Electronic control module (ECM), Horn/visible alarm output, Horn visible alarm unit, Customer contact relay connection, Remote antenna connection (2), Remote cellular antenna, Remote satellite antenna, Cellular SIM card module, Satellite communication module, Bluetooth communication module, CAN bus communication module, Modbus TCP communication module, Modbus RS428 communication module and DC power supply input. In addition, the controls may include an integrated pressure sensor. As such the pressure sensor is operative to detect a solenoid failure such as in a moment of full pressure before being opened, indicating an absence of the rise in pressure, resulting in an indication of solenoid failure. Further the pressure sensor is operative to indicate the engine power level by observing pressure value of the source or an indication that the pressurized machinery operating pressure is off.

In addition, the system of the present invention including operative features of the monitoring module include capabilities to monitor the suction pressure between an air filter and the air receiving segment of the machinery. This indicates the condition of the air filter. More specifically as the filter gets dirtier, the vacuum level increases in order to force passage of fluid flow through the dirty filter. In turn, this is indicative of a need to change the air filter. In cooperation therewith, the air filter pressure may be compared to input pressure value to set up a baseline of what is expected and therefore if there is a sudden change, while the machinery is operative, indicates that the air filters have failed or failure in an air induction system/ductwork has occurred.

### System Interface—Internal Combustion Engines

When the system of the present invention is operative to monitor an internal combustion engine, and integrated monitoring module is connected to the engine air induction system using either flexible or ridged tubing in order to monitor the combustion air for particulate contamination. Depending on the make, model and configuration of the engine, up to four (4) independent sample location points in the air induction system can be connected to the monitoring module. For larger engines with multiple air inlets/turbochargers, multi-location air sampling allows the monitoring module to isolate the location of an induction system leak and expedite repairs. Alternative versions of the monitoring system of the present invention will include additional air sample inputs for engines having more than four air intakes/turbochargers.

In most applications, the monitoring module is connected to the engine air induction system downstream of the turbo-compressor and/or supercharger outlets, such that pressurized combustion air will be supplied to the ECM for analysis. Sampling location points should be downstream of engine charge-air cooling systems, aftercoolers, intercoolers, etc. in order to detect possible leaks in those systems. Alternative versions of the monitoring system of the present invention will include the ability to sample air from upstream of the turbo-compressor and/or supercharger inlets (negative pressure) using a vacuum pump connected to the exhaust port of the ECM.

### System Interface—Combustion Turbine

The monitoring module is connected to the combustion turbine using either flexible or ridged tubing in order to monitor the combustion air for particulate contamination. Depending on the make, model and configuration of the turbine, up to four (4) independent sample location points in the air compressor section system can be connected to the monitoring module.

### System Interface—Machinery/Gearboxes

The monitoring module is connected to machine/gearbox housings using either flexible or ridged tubing in order to monitor the housing/gearbox air for particulate contamination. Depending on the make, model and configuration of the machine/gearbox housing, up to four (4) independent sample location points can be connected to the monitoring module. For machine/gearbox housings that operate under positive pressure, air samples are routed to the monitoring module housing using this positive pressure to facilitate flow through the flexible or ridged tubing connections. For machine/gearbox housings operating at ambient or negative pressure, air samples are routed to the monitoring module housing via a pump that is installed as part of the system installation such that the air samples are drawn from the machine/gearbox housing and then supplied to the monitoring module for analysis via the flexible or ridged tubing connections.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of a monitoring module integrated in the system of the present invention.

FIG. 2 is a perspective view in exploded form of the various operative components associated with the monitoring module as represented in the embodiment of FIG. 1.

FIG. 3 is a front side view of the embodiment of FIG. 1.

FIG. 4 is a schematic representation of the embodiment of FIGS. 1-3 operatively connected to one machinery category.

FIGS. 5A and 5B are schematic representations in block diagram form of the structural and operative features of one embodiment of the system of the present invention.

Like reference numerals refer to like parts throughout the several views of the drawings.

### DETAILED DESCRIPTION OF THE PREFERRED EMBODIMENT

The invention now will be described more fully hereinafter with reference to the accompanying drawings in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

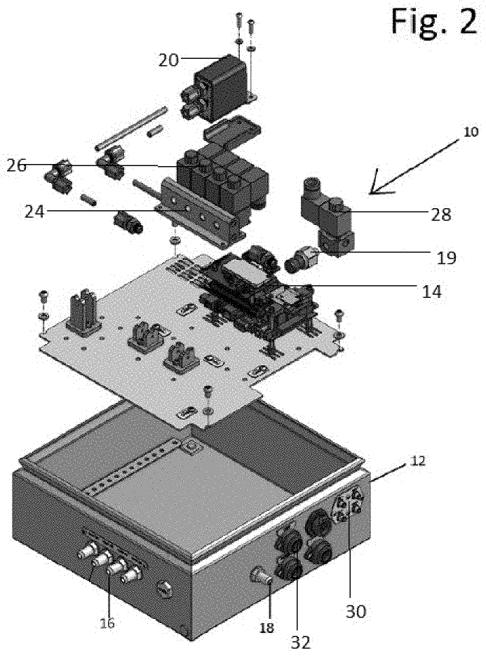

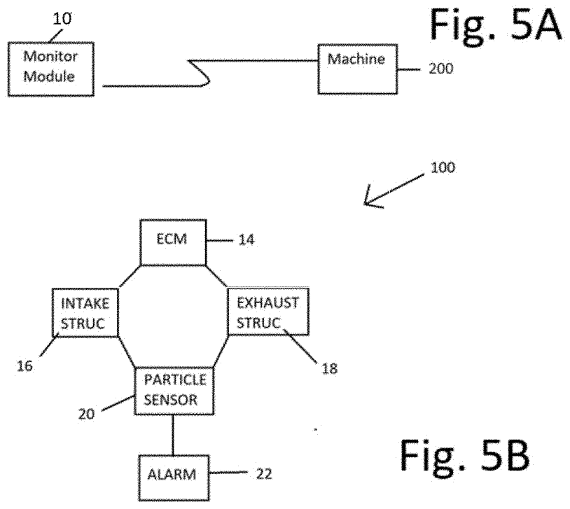

The present invention is directed to a system 100 structured to monitor particle contamination in different types or categories of positive pressure systems including, but not limited to, machinery during the operation thereof. As set forth above, it is emphasized that use of the term “machinery” and/or “machinery being monitored” and/or its equivalent refers to different positive pressure systems, which may include high-pressure electrical vault, off-road machinery with pressurized operator cabs, etc. As such and as represented in the accompanying Figures, the system 100 includes machinery 200 comprising an indicated monitoring module 10. The monitoring module 10 may be connected directly to the machinery 200 being monitored, as represented schematically in at least FIG. 5A and may be utilized in the form of a housing 12, having weatherproof capabilities, serving to enclose the remaining operative components (See FIG. 2) of the monitoring module 10.

Accordingly, one or more preferred embodiments of the system 10 of the present invention may include the following components as represented in FIG. 2: Weatherproof housing/module 12, Air sampling intake structure 16 including a plurality of intake ports 17, Air sampling manifold 24, Pressure sensor 19, Air sample solenoid control valves 26, Particle sensor 20 and sensor housing, Air sample exhaust solenoid control valve 28, air sample exhaust outlet 18, Electronic control module 14 (ECM). In addition, the housing 12 includes connectors 30 for GPS, cellular and satellite antennas as well as electrical connectors 32 for power, CanBus communications and remote horn/flasher.

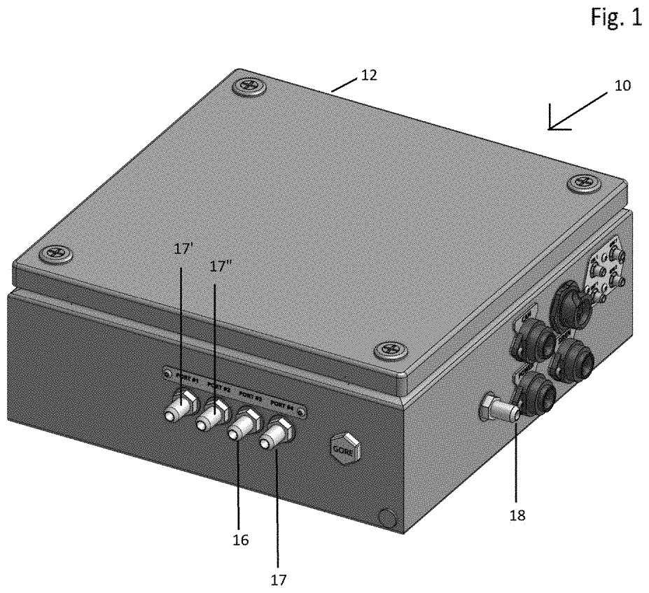

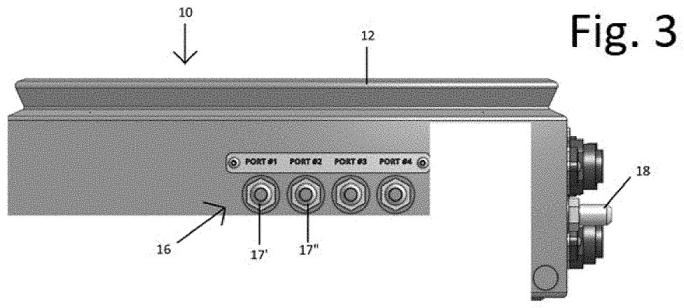

As represented in at least FIG. 5B, the monitoring module 10 includes an intake structure 16, which may comprise a plurality of one or more intake ports 17, as represented in FIGS. 1-3, as well as an air sample exhaust structure 18. In operation, the intake structure 16 is connected in fluid communication with an air induction, air intake or other appropriate air supply system of the machinery 200 being monitored.

As explained in greater detail hereinafter, at least one embodiment of the monitoring system 100 of the present invention includes the aforementioned monitoring model 10 further comprising visual and audible alarm capabilities 22 structured to communicate alarm signals to both local and remote operating personnel. Further, a particle sensor module 20 is structured to determine particle characteristics of an air sample from the machinery being monitored. An electronic control module (ECM) 14 is connected in on-off activating relation to the intake and exhaust structures 16 and 18 respectively, as well as to the particle sensor 20. Moreover, in operation the ECM 14 is operative to capture and analyze an air sample from the machinery 200 within the particle sensor 20.

In cooperation therewith, the particle sensor 20 is operative to determine the particle characteristics within the captured air sample and define predetermined particle sensor data which in turn is communicated to the to the ECM 14. As also explained hereinafter, the particle characteristics comprise at least the size, quantity and concentration of particles within the captured air sample and are representative of or define a level of particle contamination in the air of the machinery 200 being monitored. The ECM 14 is structured to analyze the particle sensor data and categorize the particle characteristics, representative of particle contamination, of the captured air sample as being either normal or abnormal.

Moreover, the particle categorization (normal or abnormal) is determined relative to a filter base-line value defined by the capabilities of a filtering system and/or filtering media within the machinery 200 being monitored. In addition, the aforementioned abnormal category of the presence of particles within the captured air sample comprises different risk levels of particle contamination. Such different risk levels include at least a pre-alarm level of contamination as well as an alarm level of contamination. Moreover, as set forth herein, and indicated pre-alarm level of contamination defines a level of contamination which is above or greater than normal levels but below levels of contamination which would damage machinery. As further defined, alarm level of contamination, in contrast to the pre-alarm level of contamination, defines a level of contamination at or above machinery damage levels, wherein such particle contamination will cause significant damage and/or breakdown of machinery being monitored.

In cooperation therewith, the ECM 14 is operative to generate corresponding pre-alarm messages as well as alarm messages to local and remote operative personnel upon the occurrence or determination, respectively, of the determination of the aforementioned pre-alarm levels or alarm levels of particle contamination. Further, the detection of the alarm level of particle contamination results in the ECM 14 being operative to activate the aforementioned alarm capabilities 22 when such machinery damaging level of contamination are detected.

The additional structural and operative features of the monitoring system 100 of the present invention include the ECM 14 being connected to the batteries of the machinery 200 being monitored, wherein such machinery 200 may include but are not limited to engines, industrial machines, turbo power systems, etc. As result, the monitoring module 10, specifically including the ECM 14 is powered whenever the monitored machinery 200 is in operation. Upon an initial power-up, the monitoring module 10 performs self-diagnostic routines to confirm readiness for operation. If any internal faults are found, the monitoring module 10 communicates a false status to the local and/or remote operative personnel and automatically enters a stand-by mode.

If no faults are detected, the ECM 14 will initiate a sequenced air-sampling or free-flow procedure by opening a control solenoid or other valve associated with intake structure 16 and/or one of the plurality of intake ports 17 thereof. Such air intake port 17 is connected to a predetermined location of the machinery 200 being monitored. The ECM 14 will simultaneously open the air sample exhaust structure 18 and/or the valve associated therewith. The operatively associated or connected intake port 17 and the exhaust structure 18 simultaneously will be opened and activated. As result, air from the machinery 200 being monitored flows freely from the intake structure 16, through the particle sensor module 20 and then exits through the exhaust structure 18.

In addition, the controls may include an integrated pressure sensor 19. As such the pressure sensor 19 is operative to detect a solenoid failure such as in a moment of full pressure before being opened, indicating an absence of the rise in pressure, resulting in an indication of solenoid failure. Further the pressure sensor 19 is operative to indicate the engine power level by observing pressure value of the source or an indication that the pressurized machinery operating pressure is off.

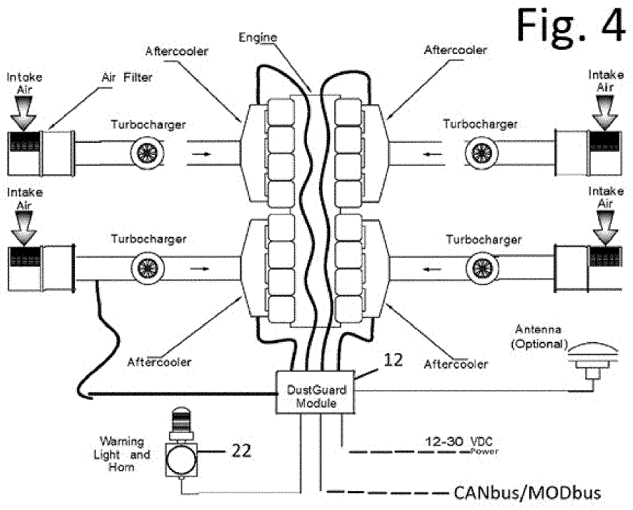

During this “free-flow” procedure, the ECM 14 disables the particle sensor module 20. Such disablement of the particle sensor module 20 is due to the fact that high internal air velocities through the particle sensor module 20 serves to decrease accuracy and reliability. By way of example only and as schematically represented in FIG. 4, when internal combustion engines are being monitored, the air passes from the exhaust structure through appropriate conduit or tubing to a suction side of the engine's air induction system and there from downstream of the air filter and upstream of the engine air inlet. As result the air sample is recycled back into the engine in a closed-loop fashion. However, for combustion turbines, gearboxes and other machine housings, the air sample is exhausted to atmosphere using one-way check valves to ensure ambient dust cannot migrate back into the enclosure creating a “false positive” alarm or contamination level indication.

After a pre-programmed and adjustable period of time such as, but not limited to 1-30 seconds, during which the free flow procedure is being performed, the ECM 14 commands the intake and exhaust structures 16 and 18 to close. This results in the capturing of an air sample within the particle sensor module 20. Due to the utilization of optical particle sensing technologies in the particle sensor module 20, the monitoring system 100 of the present invention is operative to trap or capture a sample of air received from the machinery 200, within the particle sensor module 20 such that the particle sensor 20 can be operative, via an internal fan and ducting, to accurately detect particles contamination in the captured air sample. In addition, the particle sensor module 20 is operative to isolate the particle sensors discrete air inlet and outlet pathways and also has been designed to provide an internal “reservoir” of air that can be properly drawn through the particle sensor module 20 and exhausted without creating undue restriction that would reduce accuracy and reliability. In more specific terms, the utilization of optical sensing technology may include laser light scattering capabilities, wherein at least one embodiment, may include an integrated optical particle sensor operative using laser light at 660 nm (red).

After the ECM 14 has activated aforementioned intake and exhaust structures 16 and 18 into a closed orientation the ECM 14 is operative to activate the particle sensor module 20 for a preprogrammed and adjustable period of time such as, but not limited to, generally about 1-30 seconds. The particle sensor module 20 analyzes the captured air sample and determines particle characteristics including size, quantity and concentration of particles in the captured air sample. Such particle data, having been defined or determined, is then communicated to the ECM 14 for analysis, interpretation and appropriate action.

It is to be recognized that in order to prevent false-positive alarm events, the ECM 14 is programmed to interpret the particle data, based on the determined or defined particle characteristics from each captured air sample and compare it to an established “clean air” baseline value. This clean-air baseline value is established during set up and commissioning of the monitoring system 100 of the present invention and will vary dependent upon machine's location, operating environment, machine configuration and the ability of the air filtration system associated with the machinery 200 being monitored to reduce particle contamination in the air intake or air supply to the machinery.

Moreover, the ECM 14 is programmed to interpret the particle data and make a determination as to whether the particle characteristics including particle size, quantity and/or concentration values represent a threat to the machinery 200 being monitored relative to the aforementioned filter baseline clear air values, as set forth above. The programming and structuring of the ECM 14 include sophisticated algorithms and data filtering routines to analyze each captured air sample and determine what action is required. The ECM 14 will determine if the captured air sample indicates a normal and/or expected particle sizes, quantities and/or conventions. In the alternative, the ECM 14 will be programmed and structured to determine if the captured air sample indicates abnormal particle sizes, quantities and/or client concentrations that would pose or result in damage to the machinery 200 being monitored.

If the ECM 14 determines that the captured air sample is abnormal it then assigns a risk level to the particle contamination level, wherein, by example only, a “Level 1” risk level activates a “pre-alarm” message to local and/or remote operators and supervisory personnel. In contrast, if the degree or level of contamination is at, by way of example, a “Level 2” risk, the ECM 14 activates and “alarm” message to local and remote operators. The different alert messages generated and/or transmitted by the ECM 14 allows operating personnel to assess the machine risk and take appropriate action. Therefore, a pre-the alarm message from the ECM 14 indicates the particle levels are above the baseline safe limits but below the level where rapid machine damage is expected. In contrast, the generation by the ECM 14 of an alarm message indicates particle levels are at or above the level where machine damage is expected. The versatility of the monitoring system 100 of the present invention facilitates the programming of the ECM 14 such that an end user can select from a range of values for both pre-alarm and alarm set points. This enables the monitoring system 100 to be adaptable and customizable for varying application and operational requirements.

If in fact a pre-alarm warning is triggered by the captured air sample analysis from one intake port, as at 17′ of the intake structure 17, the ECM will alert local and/or remote operating personnel of the condition and then continue the monitoring of the machinery 200 by energizing/opening a second intake port 17″ of a possible plurality of intake ports 17 of the intake structure 16 as well as cooperatively activating (opening or closing) the is exhaust structure 18 and thereafter repeating the analysis sequence as described herein above.

If an alarm warning is triggered by the analysis of the captured air sample from the aforementioned first intake port 17′ of the intake structure 16, the ECM 14 will alert the local and/or remote operating personnel of the condition. In addition, the alarm capabilities 22 including the local visual or audio alerts will also be activated and allow the aforementioned customer relay contact to be changed from an open to a closed orientation. This allows operator specified actions relating to additional controls or alarms and the continuing monitoring during the machine by energizing/opening the second 17″ of the aforementioned plurality of intake ports 17 as well as the exhaust structure 18 and repeating the analysis sequence as herein described.

The monitoring system 100 of the present invention will continue to sequentially monitor and analyze each of the plurality of air input ports 17 associated with the air intake structure 16 and send pre-alarm and/or alarm messages by the ECM 14 as appropriate after each analysis of a captured air sample. Activation of the customer contact relay and oral/visual alarms 22 are triggered during the first detected alarm event, regardless of the sequence, and will remain in the activated state until the monitoring system 100 has been manually reset by operative personnel and/or re-powered by a monitored machine 200 being turned off and then back on.

As also indicated the monitoring system 100 of the present invention, in order to provide generic pre-alarm and alarm status to local and remote operators, the ECM 14 records detailed particle data for each of the captured air samples which have been taken. This data is stored on board the ECM 14 and is available to operative personnel in order to allow more detailed analysis of air intake performance. Further, the monitoring system 100 of the present invention will allow operative personnel to analyze the performance and efficiencies of air filter media. Modern air filtration systems and filter media can represent a significant operating expense for users and the monitoring system 100 of the present invention provides a unique “on-machinery” (see FIG. 5A) technology that specifically allows operative personnel to monitor and analyze the performance of air filter media on a real-time basis in order to make more informed decisions on which air filter media/models provide the best protection for the machinery in question. Specifically, the monitoring system 100 of the present invention will allow operative personnel to determine the efficiency, reliability and durability of various air filter media in order to make informed decisions for maintenance procedures and select the best air filters for their application, considering cost, performance and operating environments.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system structured to monitor particle contamination of different positive pressure systems, said system comprising:
a monitoring module including an intake structure and an exhaust structure,
said intake structure connected in fluid communication with an air induction system of the power pressure systems,
said monitoring module further comprising:
alarm capabilities structured to communicate alarm signals to operating personnel,
a particle sensor module structured to determine predetermined particle characteristics of an air sample from the power pressure systems,
an electronic control module (ECM) connected in on-off activating relation to said intake and exhaust structures and said particle sensor,
said ECM operative to capture and analyze an air sample from the power pressure systems within said particle sensor.

2. The system as recited in claim 1 wherein said particle sensor is operative to determine said particle characteristics within said captured air sample and define predetermined particle sensor data.

3. The system as recited in claim 2 wherein said particle characteristics comprise at least size, quantity and concentration of particles within said captured air sample.

4. The system as recited in claim 2 wherein said ECM is structured to analyze said particle sensor data and categorize said particle characteristics of said captured air sample as normal or abnormal.

5. The system as recited in claim 4 wherein said ECM particle categorization is determined relative to a filter base-line value defined by filter system capabilities of the power pressure systems.

6. The system as recited in claim 4 wherein said abnormal category comprises different risk levels of particle contamination; said different risk levels include at least a pre-alarm level and an alarm level.

7. The system as recited in claim 6 wherein said pre-alarm level comprises particle contamination above normal levels and below machinery damage levels.

8. The system as recited in claim 7 wherein said alarm level comprises particle contamination at or above said machinery damage levels.

9. The system as recited in claim 6 wherein said alarm level comprises particle contamination at or above said machinery damage levels.

10. The system as recited in claim 7 wherein said ECM is operative to generate corresponding pre-alarm messages and alarm messages to operative personnel concurrent, respectively to determination of said pre-alarm level and said alarm level of particle contamination.

11. The system as recited in claim 10 wherein said ECM is operative to activate said alarm capabilities, concurrent to a determination of said alarm level of particle contamination.

12. The system as recited in claim 1 wherein said intake structure comprises a plurality of intake ports operable for active communication with the air induction system of the power pressure systems.

13. The system as recited in claim 12 wherein said ECM is structured to activate said plurality of intake ports concurrently, for intake of the air sample from the power pressure systems.

14. The system as recited in claim 12 wherein said ECM is structured to activate said plurality of intake ports successively for intake of the air sample from the power pressure systems.

15. The system as recited in claim 1 wherein said particle sensor module comprises optical sensing technology.

16. The system as recited in claim 15 wherein said optical sensing technology comprises laser light scattering capabilities including an optical particle sensor operative using laser light at 660 nm.

17. The system as recited in claim 1 further comprising an initial free-flow procedure; said free-flow procedure operatively instigated by said ECM prior to analysis of the captivated air sample within said particle sensor module.

18. The system as recited in claim 17 wherein said free-flow procedure comprises ECM activation of said intake structure and said exhaust structure in an open orientation; said open orientation activation being concurrent to said intake structure connected in fluid communication with the air induction system of the power pressure systems.

19. The system as recited in claim 18 wherein said free-flow procedure comprises the direction of airflow from the air induction system of the power pressure systems into said intake structure, through said particle sensor and out through said exhaust structure, concurrent to deactivation of said particle sensor.

20. The system as recited in claim 18 wherein said ECM is operative to maintain said free flow procedure for an adjustable, predetermined period of time, generally about between 1-30 seconds.
